(19) United States
(12) Patent Application Publication
(10) Pub. No.: US 2007/0194136 A1
(43) Pub. Date: Aug. 23, 2007

(54) Thermostatic safety valve

(76) Inventor: Aaron Christian Cunningham, Queensland (AU)

Correspondence Address: FISH & RICHARDSON PC, P.O. BOX 1022, MINNEAPOLIS, MN, 55440-1022, US

(21) Appl. No.: 10/572,651

(22) PCT Filed: Sep. 17, 2004
(86) PCT No.: PCT/AU04/01274

§ 371 Date: Jan. 18, 2007

(30) Foreign Application Priority Data
Sep. 18, 2003 (AU) 2003905087

(51) Int. Cl. G05D 23/185; G05D 23/13

(52) U.S. Cl. 236/12.11; 236/12.16

(57) ABSTRACT

A thermostatic safety valve 20 including an inlet 21, an outlet 28 and a flow path extending between the inlet and outlet. A thermostatic element 30 is disposed in the flow passage and reactable to expand or contract relative to the temperature of liquid flowing past it. A shut off device 29 is movably positioned to restrict flow of liquid through the flow passage and is movable with the thermostatic element 30 to restrict flow of liquid through the outlet 28 when the temperature of liquid received through the inlet 21 exceeds a predetermined temperature.

The present invention relates to a thermostatic safety valve principally for use in hot water delivery systems. It will be convenient to describe the invention as it relates to hot water delivery for domestic use although the invention could have broader application to other areas of hot water delivery.

A domestic hot water delivery system typically involves a storage of hot water, usually gas or electric heated water, which is stored in a tank ready for use. The hot water can be delivered direct to tap outlets at the stored temperature, or it can be tempered with cold water prior to delivery. Tempering generally takes place for safety reasons to ensure that the hot water delivered to the tap outlets is reduced in temperature. Also, tempering allows the stored water to be stored at a relatively high temperature, so that less hot water is needed to achieve a particular lower mixed temperature, and because of this, the storage tank can have a reduced capacity compared to a tank which stores water at a lower temperature. Nevertheless, it is common for water to be delivered direct without tempering, and also at very high temperatures. Particularly at high temperatures, the end user can be at risk of serious scalding, while at lower temperatures, larger storage tanks are required. It therefore is considered preferable for tempering to take place.

If cold water tempering is provided, the initial mixing of hot water from the stored supply with cold water, generally takes place through a thermostatic mixing valve, which is set to produce water mixed to a certain outlet temperature, for supply to the further outlets about the dwelling. A thermostatic valve includes an expandable element, which expands and contracts according to changes in the temperature of the water supplied to the valve to alter the proportion of the hot and cold water which is mixed together. In this respect, the temperature of the hot water supply can vary or fluctuate and it is necessary therefore to accommodate such variations and fluctuations by increasing or reducing the amount of cold water which is mixed with the hot water. By this mechanism, despite the variations and fluctuations described above, the mixed water outlet temperature can be maintained generally constant.

The expandable element of the thermostatic valve is operable to alter the proportions of hot and cold water which are mixed together, by expanding toward and away from inlet ports provided for entry of the respective hot and cold water into a mixing chamber. If the temperature in the mixing chamber exceeds the predetermined set temperature of the mixed outlet water, then the expandable element is such as to expand or contract in a manner which constricts the flow of hot water into the mixing chamber and/or in a manner to increase the amount of cold water which flows into the mixing chamber. By reducing or increasing the respective proportions of hot or cold water which enter the mixing chamber, the temperature of the mixed water which proceeds to the valve outlet, can be relatively accurately controlled.

Because the thermostatic valve employs a movable element for temperature control, the possibility exists that the element could jam or otherwise fail and if the valve arrangement is such that failure of the element would significantly increase the outlet temperature of water from the valve, then the potential also exists that the water user would be exposed to a water temperature which is significantly higher than expected. This could be dangerous for the user, particularly if element failure occurred during supply of hot water, rather than at the commencement of hot water supply.

It is an object of the present invention to attend to or at least alleviate disadvantages associated with existing hot water delivery arrangements. It is a further object of the invention to provide a valve arrangement which protects an end user against unexpected delivery of high temperature water.

According to the present invention there is provided a thermostatic safety valve for use with a liquid mixing valve, the thermostatic valve including an inlet for receiving liquid from the liquid mixing valve, an outlet, and a flow passage for liquid therebetween, a thermostatic element disposed in the flow passage and reactable to expand or contract relative to the temperature of liquid flowing past it, a shut off device which is movably positioned to restrict flow of liquid through the flow passage and which is movable with expansion or contraction of the thermostatic element, the thermostatic valve being operable to shift the shut off device to restrict flow of liquid through the outlet thereof when the temperature of liquid received through the inlet thereof exceeds a predetermined temperature.

A valve according to the present invention is principally envisaged to be used in relation to hot water supply systems. Accordingly, while the valve could be used for many different liquids, further discussion will relate to its use with water supply only.

A thermostatic safety valve according to the present invention can be formed integrally with or be arranged for connection to a hot water mixing valve, preferably to or about the outlet thereof. The safety valve therefore receives water in series from the water mixing valve and is operable to allow passage of that water therethrough while the temperature of the water remains within a preset range which is deemed to be acceptable for end use purposes.

When an event occurs such that the water which is received by the safety valve from the water mixing valve is above a predetermined temperature, the thermostatic element will expand, thereby shifting the shut off device toward a flow restricting position in which flow of water through the safety valve is substantially reduced. This may be termed “the operational safety mode”. By this mechanism if a failure occurs at the water mixing valve which results in non-tempered high temperature hot water to be released through the outlet thereof, that hot water flow is substantially terminated at the safety valve by operation of the safety valve. As a consequence, the danger to an end user is removed by substantial termination of hot water flow.

It is preferred that the shut off device not completely terminate flow of hot water in the event of a suitable failure and resultant operation of the safety valve. This is partly to ensure that the thermostatic element is not damaged by limiting the amount it can expand. If the shut off device was to completely terminate water flow, that arrangement is likely to require that device to abut against a valve seat or the like. While such abutment could adequately terminate flow completely, if the temperature to which the thermostatic element was exposed continued to increase, that element would tend to continue to expand, but if it was restrained against further expansion by an absence of further available movement in the shut off device, then the element itself may be damaged.

It is further preferred to allow a small leakage flow of hot water in the operational safety mode, because the failure of the mixing valve may be temporary only, so that upon resumption of mixed water production of the correct or an acceptable temperature, the thermostatic element of the safety valve will contract by exposure to reduced temperature water, thereby withdrawing the shut off device from its position of flow restriction and allowing recommencement of normal water flow.

Still further, a small flow through the thermostatic valve in the operational safety mode will ensure that the shut off device is maintained in the position of flow restriction, because the thermostatic element will continue to be exposed to hot water.

It is to be noted that the desirability of continued hot water leakage flow through the safety valve is only a desirable function of the valve when a failure occurs and in the immediate time period thereafter. After this, the hot water system normally would be shut down fully for maintenance prior to recommencement of hot water supply.

Alternatively, it is to be appreciated that the shut off device may be designed such that the flow of hot water terminates without leakage.

The shut off device may be activated permanently to a shut condition, for example, by using a spring loaded clip or other suitable device. This is so that the shut off device does not return to water flow in circumstances when there is an inherent fault in the hot water system that requires fixing. Permanent activation can be automatic, on operation of the safety valve, or it can be manually activated.

In a preferred arrangement, the safety valve is elongate, defining an inlet and an outlet at opposite ends thereof. In one arrangement, the inlet is formed for connection to an outlet of a mixing valve and that connection can take any form, such as snap connection or threaded connection. Alternatively, the safety valve may be formed integrally with the mixing valve, such as an integral metal or plastic casting. The safety valve may alternatively be formed separately and be connected to the mixing valve by suitable rigid or flexible pipe work or a conduit with a suitable connection arrangement provided at the inlet. An appropriate connection should also be provided at the outlet for connection of suitable pipe work or conduit.

In the above elongate form of the mixing valve, the safety valve may define an axial flow passage for axial water flow between the inlet and the outlet. The flow path may have any suitable cross-section, but preferably is circular in cross-section, although the cross-sectional diameter may change lengthwise of the flow path.

The shut off device can take any suitable form and in one preferred form, includes a piston which is arranged in the proximity of a valve seat, for movement toward and away from that seat. Movement toward the seat is such as to restrict the flow of water through the safety valve, while movement away from the valve has the effect of increasing water flow. As discussed above, actual engagement with the valve seat is not necessarily desirable. For this, the piston may be arranged to be a close fit with the seat, but not an engaging or abutting fit.

In one arrangement, the shut off device includes a piston which is circular in cross-section and arranged for receipt within a seat which defines a complementary shaped opening, with the opening being of slightly greater diameter than the external diameter of the piston, so that the piston can enter the opening to throttle flow of water through the opening, but effectively to allow a small leakage of water past the piston for the reasons explained earlier.

In an alternative arrangement, the piston may closely approach an opening through which water flow would normally take place, with the level of restriction to water flow being dependent on the closeness of approach of the piston to the opening. Still alternatively, the piston may be arranged to shift across an opening, with the level of restriction to water flow being dependent on the extent to which the piston extends across the opening. In each of these alternatives, the arrangement can be such as to fully restrict water flow, or to allow water leakage following substantial restriction of water flow.

In the preferred arrangement, the shut off device includes a cylindrical piston which is tapered at one end to define a frustoconical end portion. The piston is disposed in the flow path between the inlet and the outlet in a piston chamber which defines a valve seat at one end and the piston is arranged for movement toward and away from the seat. The frustoconical end portion provides for a more gradual cessation of flow through the safety valve if failure of the mixing valve results in a slow increase in the temperature of water entering the safety valve, rather than a sudden increase. However, a piston of this kind nevertheless is operable for generally instant or sudden shut off, if the temperature increase of the water occurs suddenly.

The piston preferably is biased towards an open position, displaced from the opening or the valve seat to allow generally unrestricted flow of water through the safety valve. This biasing influence may be required more to ensure return of the piston to the displaced position following movement of the piston towards the valve seat in the operational safety mode, rather than to maintain the piston in that displaced position. In the preferred arrangement, movement of the piston toward the seat is against the flow of water through the safety valve and the piston therefore experiences a force during normal operation under non-failure conditions that tends to push the piston away from the seat. For this reason, it can be acceptable for the biasing means to be omitted with the water pressure maintaining the piston in the open position. However, the invention also includes an arrangement in which movement of the piston in the operational safety mode is in the direction of water flow, and in that arrangement, the biasing load would maintain the piston displaced from the valve seat in non-failure conditions. A suitable biasing arrangement for either alternative could include a coil spring mounted in compression, to act on the piston. Each of the piston and the wall of the flow path can include a suitable flange or step to locate the spring ends.

The thermostatic element can take any suitable form and preferably includes an outer casing which encloses a thermally reactive material and which is mounted in the flow path and a plunger that extends from the casing in engagement with the piston. The engagement can be fixed or loose. If the engagement is fixed, then the piston will move with the plunger forward and back. However if the engagement is loose, then the plunger will be operable to push the piston, but either water pressure, spring pressure, or other means is required for return movement. The plunger is movable relative to the casing dependent on expansion or contraction of the thermally reactive material. The thermally reactive material can be elongate and coaxial with the piston. The thermally reactive material may include, but is not limited to bimetallic strips, wax, mercury or alcohol based liquids.

The attached drawings show an example embodiment of the invention of the foregoing kind. The particularity of those drawings and the associated description does not supersede the generality of the preceding broad description of the invention.

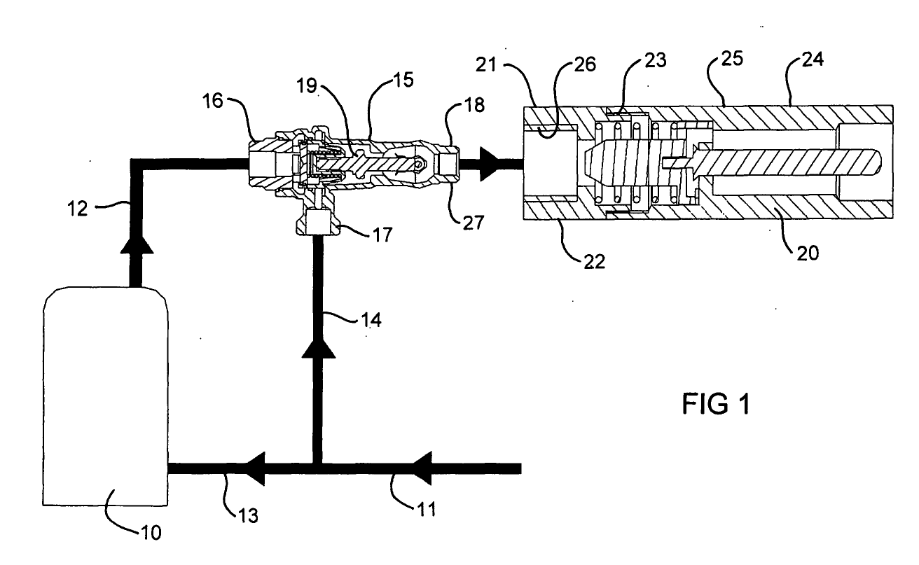

FIG. 1 is a layout drawing which includes a safety valve according to the present invention.

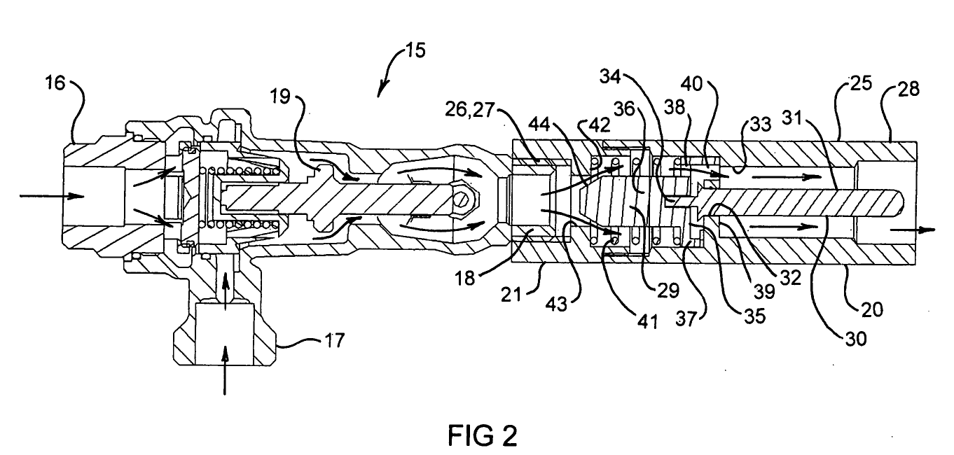

FIG. 2 shows the safety valve of FIG. 1 in larger detail.

Referring to FIG. 1, a hot water storage facility 10 is shown, which has an inlet pipe 11 and an outlet pipe 12. The inlet pipe 11 provides a supply of cold water, and the pipe 11 branches into further pipes 13 and 14, with pipe 13 extending to the storage facility 10 and pipe 14 extending to a thermostatic liquid mixing valve 15.

Cold water is supplied through the inlet pipe 13, to the storage facility 10, where it is heated to an elevated temperature. When hot water is required, it is taken from the storage facility 10 through the outlet pipe 12 for flow through the mixing valve 15. The mixing valve is operable to mix the hot water received through the inlet 16, with cold water received through the pipe 14 at the inlet 17. The mixing valve 15 is operable to mix appropriate quantities of hot and cold water to ensure that water which is discharged from the valve 15 through the outlet 18 is at or about a predetermined temperature of about 50° C. or below. The temperature of water being discharged through the outlet 18 is therefore greatly reduced compared to the temperature of water within the storage facility 10, and that reduction in temperature is essential, so that the end user is not exposed to dangerously high temperature water.

The form of the mixing valve 15 is not particularly important to the present invention. The valve 15 is shown to be a thermostatic mixing valve, in which a thermostatic element 19 is operable to control the proportions of hot and cold water which are mixed together and discharged through the outlet 18. It is the case however, that the invention is operable with other forms of mixing valve and is therefore not restricted to the thermostatic kind illustrated.

It will be appreciated that the layout shown in FIG. 1 shows the various pipes 11 to 14 and the valve 15 in greatly disproportionate scale. Likewise, it is further the case that the thermostatic safety valve 20 is also shown disproportionately large.

It will be clear from FIG. 1, that water discharged through the outlet 18 of the mixing valve 15, is directed into an inlet 21 of the safety valve 20. In this figure, the mixing valve 15 is shown separated from the safety valve 20, and while in practice this is an acceptable arrangement, it is more likely that the two valves are joined together or are formed integrally. The inlet 21 is formed in a first body section 22 of the valve 20, which is shown in threaded connection at 23, with a second body section 24. As shown, the body sections 22 and 24 are coaxial and form an elongate valve body 25.

The inlet 21 includes a threaded inner surface 26 which is arranged for threaded connection to the external surface 27 of the outlet 18 of the valve 15. This connected engagement is shown in FIG. 2 and reference will now be made to that figure. FIG. 2 shows the mixing valve 15 in threaded engagement with the safety valve 20, and this figure shows the flow path, represented by arrows, which takes place through the respective valves 15 and 20. In the state shown in FIGS. 1 and 2, the valve 15 is in normal operation, correctly or adequately mixing hot and cold water, while the safety valve 20 is also in normal operation, allowing water discharged through the outlet 18, to pass relatively unrestricted through the inlet 21 and out the outlet 28.

Disposed within the flow path shown through the valve 20, is a piston 29 and a thermostatic element 30. Referring first to the thermostatic element, this includes an outer casing 31 which is fixed in an opening 32 formed in a web 39 which extends from the internal surface 33 of the valve body 25. The outer casing 31 is therefore fixed against movement relative to the valve body 25.

The thermostatic element 30 further includes a plunger 34 which extends from the outer casing 31 into engagement with a rear end 35 of the piston 29. The plunger 34 can be rod like, or key like, with an appropriate complimentary opening formed in the piston 29. The plunger 34 may be fixed within the opening of the piston 29 such as by adhesive or suitable fastener, or by a friction fit. Otherwise the plunger can be a loose fit in an opening in the piston.

The piston 29 has a main body section 36 and a flange section 37. The flange section 37 includes a plurality of flow openings 38, while the web 39 which defines the opening 32, also includes relevant openings for passage of water flow.

A coil spring 41 is disposed between an internal land 42 extending from the internal surface 33 of the valve 20, and at the other end against the flange section 37 of the piston 29. The coil spring 41 therefore acts as a return spring on the piston 29, to bias it towards the open position shown.

The land 42 forms part of a valve seat with which the piston 29 cooperates upon failure of the mixing valve 15 which results in substantially or fully non-tempered hot water proceeding through the valve 15 for discharge through the outlet 18 into the safety valve 20. The valve seat also includes the opening 43.

Under normal conditions, hot water flowing into the safety valve 20 passes about the forward end 44 of the piston 29, which end is formed tapered, or frustoconical, in order to limit the restriction to water flow that the piston imposes during normal running conditions of the safety valve 20 and water flows through or about the coil spring 41, through the openings 38 and 40, and past the thermostatic element 30 for discharge through the outlet 28. Upon failure of the mixing valve 15 occurring such that substantially non-tempered hot water flows into the safety valve 20, the temperature of water flowing past the thermostatic element 30 increases greatly, and that causes the plunger 34 to extend outwardly of the outer casing 31, pushing the piston 29 against the influence of the return spring 41, and causing the forward end 44 to more fully enter the opening 43. Advancement of the piston 29 in this manner reduces the space available for water flow past the forward end 44, and thereby restricts the volume of subsequent water flow through the valve 20.

It can be appreciated that the diameter of the piston 29 is close to but slightly less than the diameter of the opening 43, so that upon extension of the piston 29 into the opening 43 sufficiently for the main body section 36 to enter the opening 43, that substantial restriction to water flow through the valve 20 is achieved. However, because the main body section 36 has a slightly lesser diameter than the opening 43, some leakage of water past the piston 29 will occur, and that may be advantageous for the reasons expressed earlier herein.

If failure of the valve 15 is short term only, and whatever caused the failure remedies itself, then cold water will again mix with hot water within the valve 15 for discharge through the valve 18, and the lower temperature leakage that occurs will flow past the outer casing 31, cooling the thermostatic element 30 and causing retraction of the plunger 34. The piston 29 will thereby return either under the influence of the plunger 34, the return spring 41, or water pressure and normal flow will recommence through the safety valve 20. Alternatively, if the valve 15 fails permanently, the piston 29 will remain in an extended position within the opening 43 and will maintain restriction to fluid flow so long as leakage occurs at an elevated temperature.

Alternatively, the piston 29 may be configured such that it utilises a non-resetting function to permanently remain in an extended position restricting fluid flow.

The present invention clearly provides an advantageous mechanism for ensuring that an end user is not exposed to non-tempered high temperature water in times of failure of a mixing valve. Advantageously however, at times other than failure conditions, the safety valve 20 imposes no real influence on the flow of mixed hot water.

The invention described herein is susceptible to variations, modifications and/or additions other than those specifically described and it is to be understood that the invention includes all such variations, modifications and/or additions which fall within the spirit and scope of the above description.

1. A liquid mixing valve, said mixing valve including a first inlet for receiving heated water from a water heater, a second inlet for receiving non-heated water from a water supply, a mixing chamber for mixing water from said first and second inlets and a discharge outlet for discharge of said mixed water from said mixing chamber, a first thermostatic element being disposed within said mixing chamber for controlling the proportions of heated and non-heated water that are mixed within said mixing chamber so that the temperature of the mixed water which is discharged from said mixing chamber does not exceed a predetermined upper temperature and whereby, upon increase of the temperature of the mixed water in the mixing chamber above the predetermined upper temperature, the first thermostatic valve is operable to substantially terminate the flow of water through said discharge outlet, said liquid mixing valve further including a safety valve which includes an inlet in communication with said discharge outlet, an outlet, and a flow passage for liquid therebetween, a second thermostatic element disposed in the flow passage and reactable to expand or contract relative to the temperature of liquid flowing past it, a shut off device which is movable with expansion or contraction of the second thermostatic element, the second thermostatic element being operable to shift the shut off device to a shut off position to substantially terminate flow of liquid through the outlet of the safety valve upon failure of the first thermostatic element to substantially terminate flow of water through the discharge outlet when the temperature of the water in the mixing chamber exceeds the predetermined temperature.

2. A liquid mixing valve according to claim 1, said flow passage extending axially between said inlet and said outlet.

3. A liquid mixing valve according to claim 2, said flow passage being circular in cross-section.

4. A liquid mixing valve according to claim 3, wherein the diameter of said flow passage changes through the length of said flow passage

5. A liquid mixing valve according to claim 1, said shut off device including a piston which is positioned in proximity of an opening of said flow passage, for movement toward and away from said opening.

6. A liquid mixing valve according to claim 5, said piston being arranged to closely approach said opening.

7. A liquid mixing valve according to claim 5, wherein said opening has a valve seat formed about it and said piston can move into engagement with said valve seat to close said opening.

8. A liquid mixing valve according to claim 5, wherein said piston is generally cylindrical and includes a conical or frustoconical axial end portion in facing relationship with said opening.

9. A liquid mixing valve according to claim 1, said shut off device including a piston which is circular in cross-section and is arranged for receipt within a circular opening formed in said flow passage, said circular opening having a slightly greater diameter than the external diameter of said piston so that said piston can enter said opening to restrict flow of water through said opening without fully closing said opening.

10. A liquid mixing valve according to claim 9, wherein said piston includes a frustoconical axial end portion in facing relationship with said opening.

11. A liquid mixing valve according to claim 1, said shut off device including a piston which is positioned in proximity to an opening formed in said flow passage, said piston being arranged for movement across said opening to restrict flow of water through said opening.

12. A liquid mixing valve according to claim 1, wherein when said shut off device has moved to substantially restrict flow of liquid through said outlet of said safety valve, said shut off device allows a small amount of liquid to continue to flow past said thermostatic element.

13. A liquid mixing valve according to claim 1, wherein said shut off device includes a piston and biasing means to bias said piston to a position allowing generally unrestricted flow of liquid through said safety valve.

14. A liquid mixing valve according to claim 1, wherein said shut off device includes a piston which is positioned so that flow of liquid through said flow passage acts on said piston in a direction tending to shift said piston to a position allowing generally unrestricted flow of liquid through said safety valve.

15. A liquid mixing valve according to claim 1, wherein said shut off device includes a piston which is positioned so that flow of liquid through said flow passage acts on said piston in a first direction tending to shift said piston to a position to substantially restrict flow of liquid through said flow passage, and biasing means are provided to bias said piston in a second and reverse direction.

16. A liquid mixing valve according to claim 15, said biasing means being a coil spring mounted in compression to act on said piston.

17. A liquid mixing valve according to, said second thermostatic element including an outer casing, a thermally reactive material within said casing, and a plunger, the plunger being movable upon expansion or contraction of said thermally reactive material, said shut off device including a piston and said plunger being in engagement with said piston to shift said piston upon expansion or contraction of said thermally reactive material.

18. A liquid mixing valve according to claim 17, said engagement being fixed engagement.

19. A liquid mixing valve according to claim 17, said engagement being abutting engagement.

20. A liquid mixing valve according to claim 17, said casing being fixed against movement within said flow passage.

21. A liquid mixing valve according to claim 1, said mixing valve being elongate and defining an axial flow passage between one of said first and second inlets, said discharge outlet, said inlet of said safety valve and said outlet of said safety value.

22. A water delivery system, including a water supply, a water heater and a liquid mixing valve, said water heater including a tank having an inlet for receiving water from said water supply and an outlet for discharge of heated water, said liquid mixing valve including a first inlet for receiving heated water from a water heater, a second inlet for receiving non-heated water from a water supply, a mixing chamber for mixing water from said first and second inlets and a discharge outlet for discharge of said mixed water from said mixing chamber, a first thermostatic element being disposed within said mixing chamber for controlling the proportions of heated and non-heated water that are mixed within said mixing chamber so that the temperature of the mixed water which is discharged from said mixing chamber does not exceed a predetermined upper temperature and whereby, upon increase of the temperature of the mixed water in the mixing chamber above the predetermined upper temperature, the first thermostatic valve is operable to substantially terminate the flow of water through said discharge outlet, said liquid mixing valve further including a safety valve which includes an inlet in communication with said discharge outlet, an outlet, and a flow passage for liquid therebetween, a second thermostatic element disposed in the flow passage and reactable to expand or contract relative to the temperature of liquid flowing past it, a shut off device which is movable with expansion or contraction of the second thermostatic element, the second thermostatic element being operable to shift the shut off device to a shut off position to substantially terminate flow of liquid through the outlet of the safety valve upon failure of the first thermostatic element to substantially terminate flow of water through the discharge outlet when the temperature of the water in the mixing chamber exceeds the predetermined temperature.
